(19) United States
(12) Patent Application Publication
(10) Pub. No.: US 2015/0373069 A1
(43) Pub. Date: Dec. 24, 2015

(54) MANAGING A COMMON SHARED PLAY QUEUE ON MULTIPLE DEVICES

(71) Applicant: Blackfire Research Corporation, San Francisco, CA (US)

(72) Inventor: Ravi Rajapakse, San Francisco, CA (US)

(21) Appl. No.: 14/746,806

(22) Filed: Jun. 22, 2015

Related U.S. Application Data
(60) Provisional application No. 62/015,374, filed on Jun. 20, 2014.

(51) Int. Cl. H04L 29/06; H04L 12/861

(52) U.S. Cl. CPC H04L 65/4076; H04L 49/90

(57) ABSTRACT

A system for managing a shared play queue, comprising a queue manager that stores and modifies a media playback queue comprising media file identifiers, and configured to communicate via a network to broadcast a media playback queue and listen for media playback queue broadcasts received via the network, and to modify a media playback queue based on a received broadcast, and a method for managing a shared play queue.

### CROSS-REFERENCE TO RELATED APPLICATIONS

This application claims the benefit of, and priority to, United States provisional patent application Ser. No. 62/015,374, titled “MANAGING A COMMON SHARED PLAY QUEUE ON MULTIPLE DEVICES” and filed on Jun. 20, 2014, the entire specification of which is incorporated herein by reference in its entirety.

### BACKGROUND OF THE INVENTION

1. Field of the Art

The disclosure relates to the field of electronic multimedia playback, and more particularly to the field of utilizing a single, shared playback queue on a plurality of playback devices.

2. Discussion of the State of the Art

When multiple users are able to play to, and experience music on, the same audio system, there is a need to share a common playlist amongst these smartphone users. In such an application, it is desirable, not to have a master smartphone or other device that controls or manages the common play queue. It is desirable that all devices have equal access and management of this play queue. However, it is also a requirement that the media on each device not be copied to each other's devices, to limit bandwidth use and to honor copyright issues. This is particularly important, as it may be the case, that the media to be played by some devices is from a media service that requires a subscription.

What is needed, is a system to provide a network between multiple mobile devices and operate a media playback queue shared among all devices within the network, and to enable users to view and add media to the shared queue from their device.

### SUMMARY OF THE INVENTION

Accordingly, the inventor has conceived and reduced to practice, in a preferred embodiment of the invention, a system where users of smartphones in a group of smartphones on the same network “subnet”, can view and add media to a common play queue. The system is designed, so that the media on the common play queue is played from the smartphone that added and owns that particular media.

According to a preferred embodiment, a system for managing a common play queue on multiple devices comprising a queue manager comprising at least a plurality of programming instructions stored in a memory operating on a network-connected computing device and configured to store and modify at least a media playback queue, the media playback queue comprising at least a plurality of media file identifiers, and configured to communicate via a network, wherein the queue manager broadcasts at least a portion of a media playback queue via the network and listens for media playback queue broadcasts received via the network, and further configured to modify at least a portion of a media playback queue based at least in part on a received broadcast, is disclosed.

According to another preferred embodiment of the invention, a method for managing a shared media playback queue, comprising the steps of: configuring, at a queue manager, a media playback queue; broadcasting at least a portion of the media playback queue via a network; receiving, at a queue manager, a broadcast media playback queue; and playing media based at least in part on at least a portion of the media playback queue, is disclosed. According to the embodiment, the method for managing a shared play queue may comprise the steps of queuing media for playback on a playback device (such as a smartphone or other suitable device), broadcasting the queue information (optionally including media or device identifiers for the purposes of synchronization and queue management, as described below) over a network (such as a BLUETOOTH™ or WiFi connection, as are common in such media devices), receiving at a destination media device the queue information, optionally comparing the received play queue information to existing queue information (if present, for example such information may be present when updating a previous queue, but may be omitted if receiving an initial play queue broadcast), updating previous information if needed, and commencing playback (ideally, in a synchronized fashion with other playback devices sharing the same queue, such as by utilizing media information as described below).

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram illustrating an exemplary system architecture for managing a shared play queue, according to a preferred embodiment of the invention.

FIG. 6 is a method flow diagram illustrating an exemplary method for managing a shared play queue, according to another preferred embodiment of the invention.

### DETAILED DESCRIPTION

The inventor has conceived, and reduced to practice, in a preferred embodiment of the invention, a system where users of smartphones in a group of smartphones on the same network “subnet”, can view and add media to a common play queue. The system is designed, so that the media on the common play queue is played from the smartphone that added and owns that particular media.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

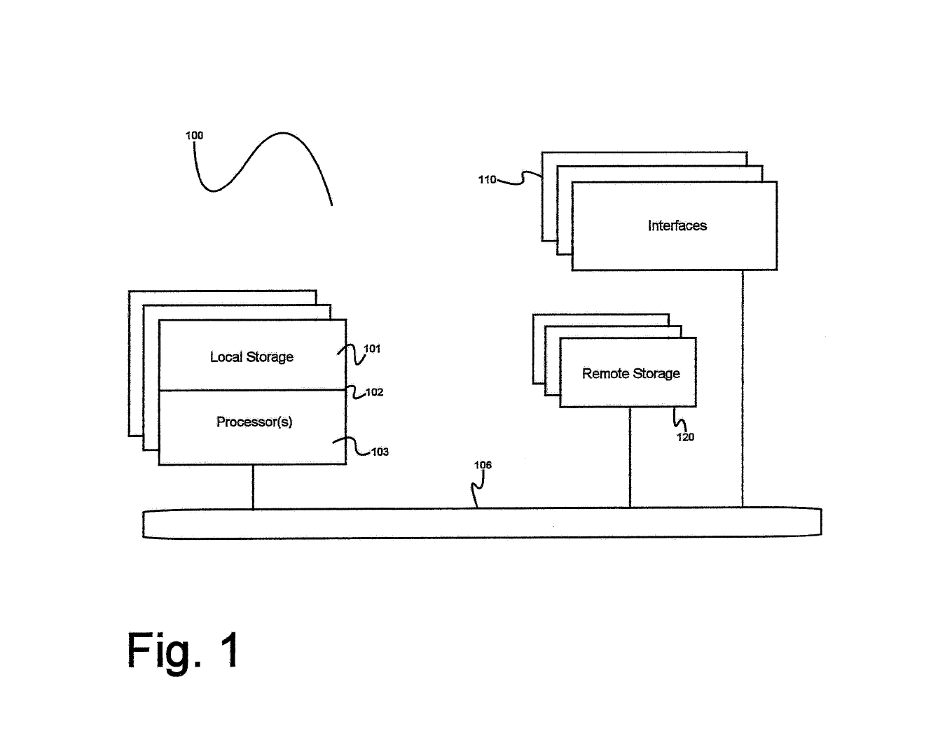

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

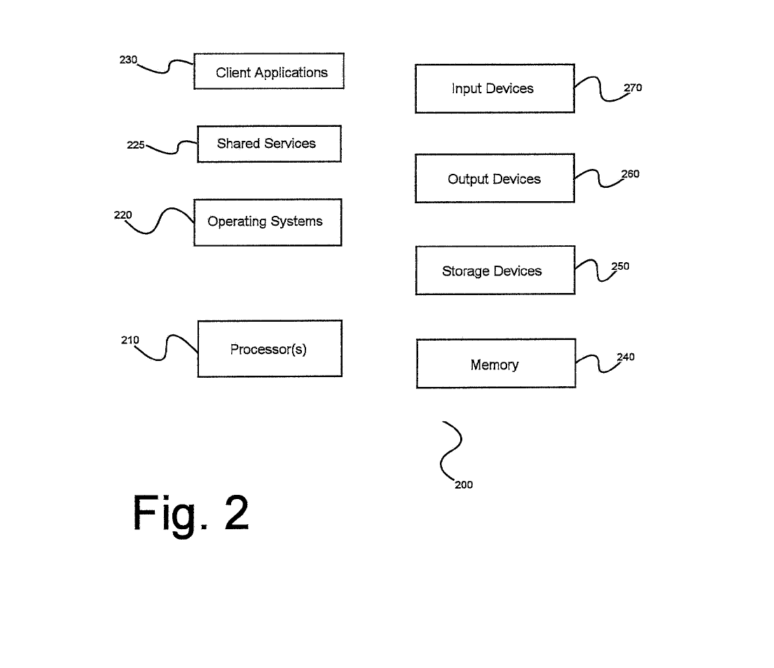

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

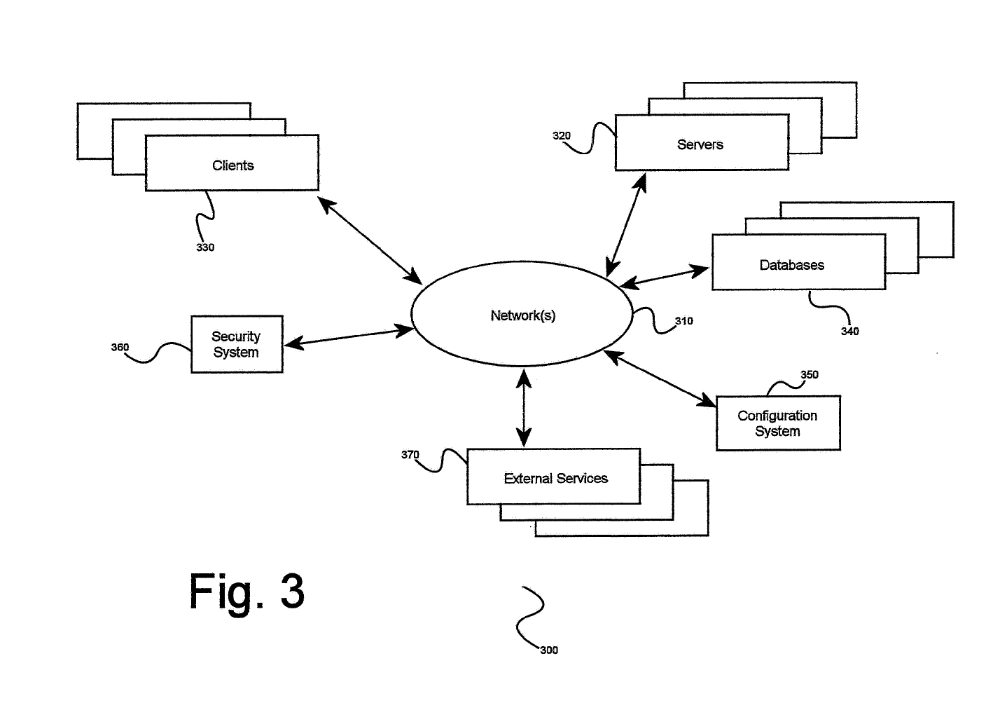

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

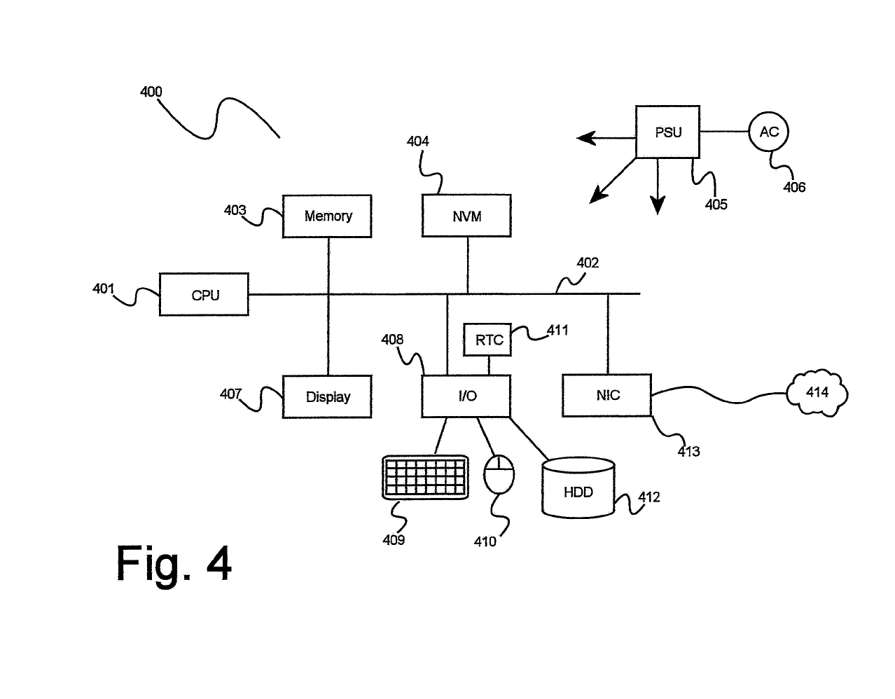

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

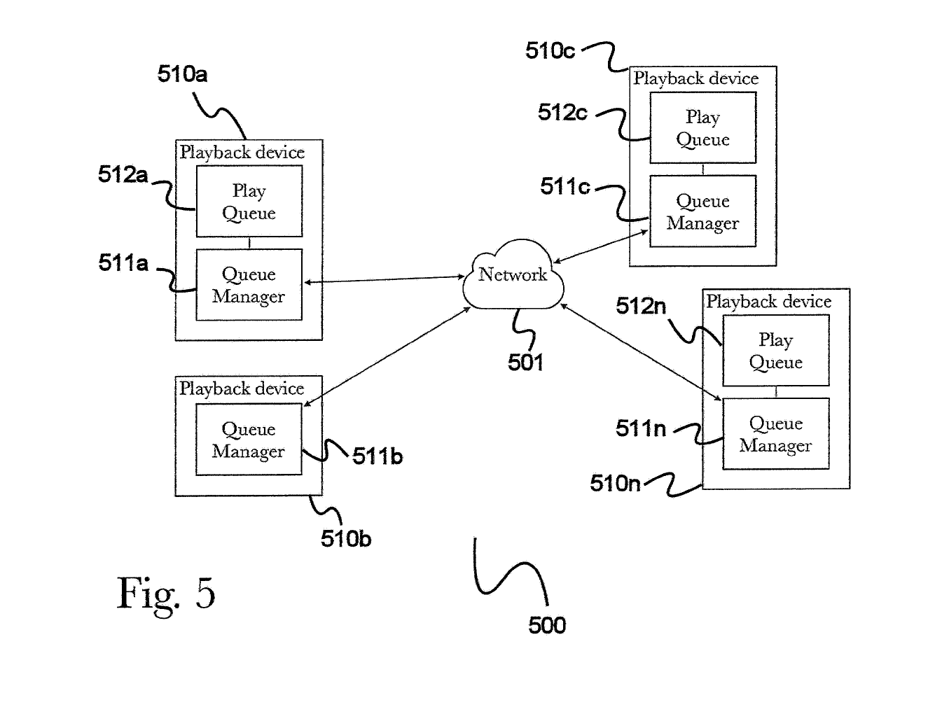

FIG. 5 is a block diagram illustrating an exemplary system architecture 500 for managing a shared play queue, according to a preferred embodiment of the invention. According to the embodiment, a plurality of playback devices 510a-n may communicate via a network 501 such as the Internet or other suitable data communication network. Network protocols or arrangement may vary widely according to the embodiment, for example devices may connect to an existing WiFi network or may use ad-hoc or “mesh” networking to create a new network on-demand between devices (for example, for operating a shared playback queue according to the embodiment in a location where there may be no existing network infrastructure, such as on a camping trip or during in-flight travel).

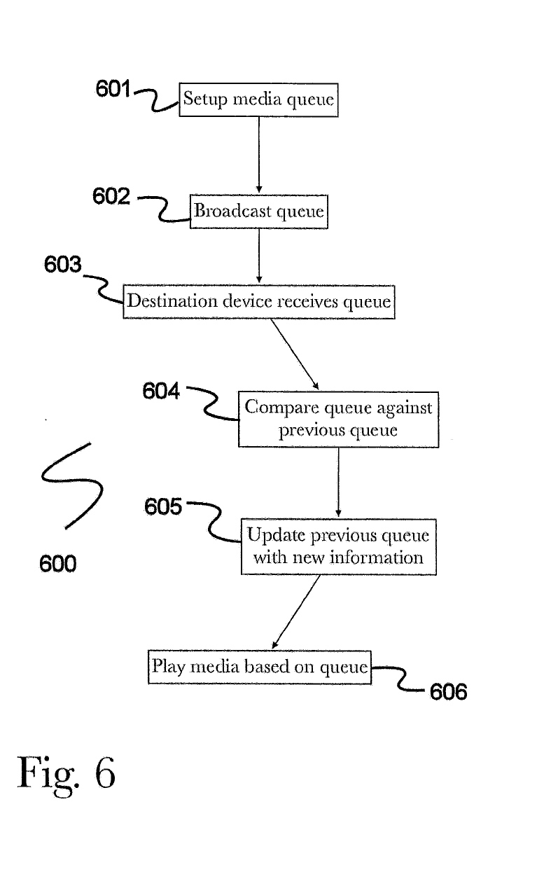

A playback device 510a may operate a queue manager 511a, comprising at least a plurality of programming instructions stored in a memory operating on device 510a and configured to store and operate a plurality of data comprising at least a media playback queue 512a. Queue information may comprise, for example, a plurality of media file identifiers (such as song or video names, or assigned unique identifiers each corresponding to a particular media file for playback), a playback order, configured volume levels or equalizer settings, or any other media file or configuration information. Additionally, a queue manager 511a may communicate via a network 501 to provide queue information to other devices and to receive queue information from other devices. In this manner, a playback queue may be shared between devices on a network, for example via the method described below in FIG. 6.

According to the embodiment, a device 510b may operate a queue manager 511b without maintaining a copy of a playback queue. In such an arrangement, device 510b may function as an interface to a playback queue, enabling a user to modify queue information on other devices without storing a local copy or playing media on device 510b. In this manner a queue may be interacted with using a device that may ordinarily be unsuitable for media playback, for example a device without audio speaker hardware or with limited system resources. Additionally, in such an arrangement a queue manager 511b may be provided as a software-based application programming interface (API), enabling integration with third-party devices or services, for example to enable interaction with a playback queue via a web browser. Another alternate arrangement may utilize a queue manager 511b operating on a server computer, interacting with media playback queues via a network. In such an arrangement, a user may connect to queue manager 511b via a web browser or software application, and interact with queue manager 511b such as to modify a play queue, which may then be broadcast by the server to all connected playback devices.

It should be appreciated that a play queue may be stored only on a single playback device, for example when a user sets a queue and then shares it with other devices on a network. It should be further appreciated that a play queue may also be present on multiple devices, such as after a queue sharing takes place, and in such an arrangement there may not be a “master” device, and all devices with play queues are equally able to alter the queue and then re-broadcast it according to the method described below. In this manner, a shared play queue may be utilized and managed by multiple users on multiple devices, and everyone may have similar “permissions” regarding the queue itself.

### Detailed Description of Exemplary Embodiments

FIG. 6 is a method flow diagram illustrating an exemplary method 600 for managing a shared play queue, according to another preferred embodiment of the invention. In an initial step 601, a queue manager operating on a source device (such as a personal computer or a mobile device, for example a smartphone) may set up a media queue, for example by a user manually configuring a queue (generally by selecting media for playback and configuring any additional options such as play order or equalizer settings), or by reading a stored configuration file such as a saved playlist or a user's preferred default configuration. In a next step 602, the queue may be broadcast, for example using a subnet mask to reach any devices connected to the same network subnet as the queue manager. In a next step 603, a destination device (for example, a media player or smartphone) may receive a queue broadcast via a network. In a next optional step 604, a received broadcast queue may be compared against a previous queue, for example if a media player already had a playback queue configured. If a previous queue is present, in a next step 605 a destination device may update a previous queue with new information received from a broadcast, effectively updating a stored queue to match that which was broadcast. In a final step 606, media may be played based on a playback queue, for example at one or more destination devices or at a source device (such as if no devices were found on the network and a user wishes to simply play media on their device based on the queue). The steps of method 600 are described in greater detail below.

Periodically each device 510a-n may broadcast (for example, using a multicast network messaging protocol), a common play queue. This may be accomplished by broadcasting common play queue properties, such as including the number of items in the play queue or their order (for example, if playing multiple songs in an ordered fashion, rather than “shuffling” them) and then broadcasting each item in a common play queue to all other devices that might be listening (for example, by broadcasting using a subnet mask so that all devices on a subnet may receive the message). For each item, broadcast information may comprise (for example) media properties such as a media item ID like a track number in an album or an arbitrary assigned unique identifier (UID), media name (such as a song or video title), or the ID of the device that added that media item to the common play queue (for example, a smartphone's device name or a device's unique hardware MAC address).

According to the embodiment, each device that receives such a common play queue broadcast may compare the media items in the play queue that is broadcast with any media items on its local common play queue. If the broadcast common play queue has media items that are not on the local common play queue, these media items are added to the local common play queue. In this manner all the receiving smartphones, synchronize their local common play queues with the common play queues that are broadcast.

In order to uniquely identify each device, it may be appreciated that a unique identifier is needed, such as a device ID. According to the embodiment, the MAC address (media access control address) of the WiFi adapter of the device may be used as this identifier, and this is particularly suitable because every network interface (such as a WiFi adapter or other network interface component) will have exactly one MAC ID assigned to it, which is unique and generally difficult or impossible to tamper with. The MAC address is globally unique by design and managed by the Institute of Electrical and Electronic Engineers, providing a consistent and scalable means of uniquely identifying devices for purposes of the embodiments.

Furthermore, each media item also needs to be uniquely identified, such as with a media item ID. According to the embodiment, the MAC address of the device and a sequential number may be joined together as the media item ID, as a suitable means of producing unique identifiers for each media item that may be related to both a media item and a source device (that is, the device from which the media item originated). The sequential number component may be a sequentially incrementing number created when the media item is added to the common play queue, or may be generated according to a variety of algorithms according to a particular arrangement. The media item ID is a property broadcast with each media item and compared to the media item ID of the media items in the local common play queue to check if this item already exists in the local Common play queue.

Whenever a user adds a media item to the common play queue, an “add media item to common play queue” message (for example, this description is a general representation of the content of such a message and it should be appreciated that the specific data and structure of a message may vary greatly according to a particular arrangement, network protocol, communication interface, or a variety of other factors) may be sent to all devices, that allows them to update all their respective local common play queues. For example, such a message may generally include necessary media identification information, such as a unique media ID as described previously, and any additional playback queue information such as the position or configuration settings applicable to the new media item.

Any user can initiate playing from the common play queue, by selecting a queue to be played. When the common play queue is being played, each device may monitor the play queue to determine if the next media item to be played in the play queue is media from that device (that is, each device may continually check to see if it is responsible for providing the next media item for playback). If this is the case, once the current media play is finished, it will initiate playback of the media item. In this manner, a number of devices may each contribute their own local media (or media to which they have access, for example by pulling in media from a user's cloud storage or an online subscription to a service such as PANDORA™, SPOTIFY™ or other such media sources), while other devices may merely “listen” to the media until they need to provide their own (for example when an upcoming item in a queue is sourced from that device).

Once a media item is being played, that device may broadcast a “heartbeat” message periodically to all other devices that that media item is being played. If any device fails to receive this “heartbeat” message, it may regard the current (playing) source as having dropped out of the playlist group and may then broadcast this information, and every other device may remove all media belonged to the lost user. This will prevent long periods of waiting while a current playing user has left accidentally, such as due to network, hardware, or software difficulties.

When a new user joins a playlist group, the whole list of media in the queue may be sent for refresh, so the new player may be synchronized with existing players. When the playback of a media item has ended, that device may broadcast a message to all other media devices that the playback of that media items has ended. This will allow the device that should play the next song in the common play queue to play its media item.

The skilled person will be aware of a range of possible modifications of the various embodiments described above. Accordingly, the present invention is defined by the claims and their equivalents.

What is claimed is:

1. A system for managing a shared play queue, comprising:
a queue manager comprising at least a plurality of programming instructions stored in a memory of and operating on a processor of a network-connected computing device and configured to store and modify at least a media playback queue, the media playback queue comprising at least a plurality of media file identifiers, and configured to communicate via a network, wherein the queue manager broadcasts at least a portion of a media playback queue via the network and listens for media playback queue broadcasts received via the network, and further configured to modify at least a portion of a media playback queue based at least in part on a received broadcast.

2. The system of claim 1, wherein the queue manager operates on a server computer.

3. The system of claim 1, wherein the queue manager further comprises a software application programming interface comprising at least a plurality of programming instructions stored in a memory and operating on a network-connected computing device, and configured to receive communication via a network.

4. A method for managing a shared media playback queue, comprising the steps of:
configuring, at a queue manager, a media playback queue;
broadcasting at least a portion of the media playback queue via a network;
receiving, at a queue manager, a broadcast media playback queue; and
playing media based at least in part on at least a portion of the media playback queue.

5. The method of claim 4, further comprising the step of comparing a broadcast media playback queue against a stored media playback queue.

6. The method of claim 5, further comprising the step of updating a stored media playback queue based at least in part on at least a portion of the broadcast media playback queue.
